(19) United States
(12) Patent Application Publication
(10) Pub. No.: US 2015/0011723 A1
(43) Pub. Date: Jan. 8, 2015

(54) ORGANOSILICON COMPOUNDS AND THEIR USE THEREOF FOR PRODUCING HYDROPHILIC SURFACES

(71) Applicant: Wacker Chemie AG, Munich (DE)

(72) Inventors: Marko Prasse, Glaubitz (DE); Uwe Scheim, Coswig (DE)

(21) Appl. No.: 14/380,805

(22) PCT Filed: Feb. 26, 2013
(86) PCT No.: PCT/EP2013/053791

§ 371 Date: Aug. 25, 2014

(30) Foreign Application Priority Data
Mar. 1, 2012 (DE) 10 2012 203 274.6

(51) Int. Cl. C07F 7/08; C08G 77/18

(52) U.S. Cl. CPC C07F 7/0818; C08G 77/18
USPC 528/41; 556/437

(57) ABSTRACT

Organosilicon compounds used for production of hydrophilic surfaces are prepared via an addition reaction of epoxy-functional silanes onto polyethylene glycols, cross-linked via a condensation reaction, and used for modification of substrate surfaces such as hardened silicone elastomers, glass surfaces, surfaces of silicatic construction materials, metals, and plastics.

### CROSS-REFERENCE TO RELATED APPLICATIONS

This application is the U.S. National Phase of PCT Appln. No. PCT/EP2013/053791 filed Feb. 26, 2013, which claims priority to German application DE 10 2012 203 274.6 filed Mar. 1, 2012, the disclosures of which are incorporated in their entirety by reference herein.

### BACKGROUND OF THE INVENTION

1. Field of the Invention

The invention relates to organosilicon compounds, processes for producing organosilicon compounds, and also use of organosilicon compounds, for the production of hydrophilic surfaces, and particularly to compositions, preparations, and materials which comprise the compounds or which have been coated with the compounds.

2. Description of the Related Art

The production of hydrophilic surfaces is desirable in many sectors. In the case of construction materials and construction auxiliaries, hydrophilic surfaces can be desirable to reduce droplet formation, for faster run-off of water and condensate, and thus for faster drying and avoidance of lime deposits and residues from the water. Hydrophilic surfaces can prevent fogging of optical components, glasses, and windows. In the case of silicones, hydrophilic surfaces can retard adhesion of microorganisms and salt deposits and contamination by organic substances. Hydrophilic surfaces improve antistatic properties of nonconductors.

JP 2009184888 A2 describes compounds of the

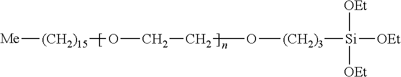

type which are produced from the PEG alcoholate and chloropropyltriethoxysilane, and are used for the production of mesoporous structures.

CN 1451471 A describes compounds of the

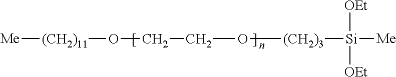

type which are produced from the PEG alcoholate and chloropropylmethyldiethoxysilane and are used in single-component water-based products.

U.S. Pat. No. 4,844,980 A describes compounds of the

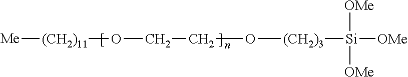

type which are produced from the PEG alcoholate and chloropropyltrimethoxysilane, and which are used for the coating of particles.

JP 2008032860 A2 describes compounds of the

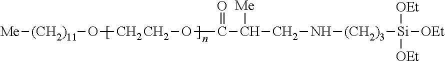

type which are produced from the PEG methacrylate and 3-aminopropyltriethoxysilane, and are used in curable compositions.

EP 406731 B1 describes compounds of the

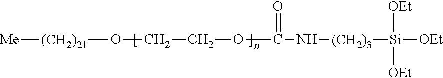

type which are produced from the alkyl-PEG and 3-isocyanatopropyltriethoxysilane and are used for the surface treatment of mica.

U.S. Pat. No. 5,354,881 A likewise describes compounds which are produced from alkyl-PEG and isocyanato-functional silanes.

The production processes for the abovementioned compounds have the disadvantage of using inaccessible and/or expensive feedstocks or the disadvantage of a necessity to remove byproducts.

### SUMMARY OF THE INVENTION

The invention provides compounds of the formula

(R¹O)ₐR₃₋ₐSi-A-O(CH₂CH₂—O)ₓ—R² (I),

where

R can be identical or different and represents a monovalent, optionally substituted hydrocarbon radical,

R¹ can be identical or different and represents a hydrogen atom or a monovalent, optionally substituted hydrocarbon radical,

A is a divalent, optionally substituted hydrocarbon radical, which comprises a hydroxy group and an ester group (—O—C(═O)—), and which can be interrupted by oxygen atoms, and which is bonded via carbon to Si and to O,

R² represents a monovalent, optionally substituted hydrocarbon radical having 8 to 20 carbon atoms,

a is 1, 2, or 3, preferably 2 or 3, more preferably 3, and

x is an integer from 1 to 20, preferably an integer from 2 to 15, most preferably an integer from 3 to 10.

### DETAILED DESCRIPTION OF THE PREFERRED EMBODIMENT

Examples of radicals R are alkyl radicals such as the methyl, ethyl, n-propyl, isopropyl, 1-n-butyl, 2-n-butyl, isobutyl, tert-butyl, n-pentyl, isopentyl, neopentyl, and tert-pentyl radicals; hexyl radicals such as the n-hexyl radical; heptyl radicals such as the n-heptyl radical; octyl radicals such as the n-octyl radical, isooctyl radicals, and the 2,2,4-trimethylpentyl radical; nonyl radicals such as the n-nonyl radical; decyl radicals such as the n-decyl radical; dodecyl radicals such as the n-dodecyl radical; octadecyl radicals such as the n-octadecyl radical; cycloalkyl radicals such as the cyclopentyl, cyclohexyl, cycloheptyl radical, and methylcyclohexyl radicals; alkenyl radicals such as the vinyl, 1-propenyl, and the 2-propenyl radical; aryl radicals such as the phenyl, naphthyl, anthryl and phenanthryl radical; alkaryl radicals such as o-, m-, p-tolyl radicals; xylyl radicals and ethylphenyl radicals; and aralkyl radicals such as the benzyl radical, the α- and the β-phenylethyl radical.

Preferably, radical R is a hydrocarbon radical having 1 to 12 carbon atoms, more preferably methyl, ethyl, vinyl, or phenyl radical, and in particular the methyl radical.

Examples of optionally substituted hydrocarbon radicals R¹ are the examples given for radical R.

The radicals R¹ are preferably hydrogen or halogen-substituted hydrocarbon radicals having 1 to 18 carbon atoms, more preferably hydrogen or hydrocarbon radicals having 1 to 10 carbon atoms, in particular hydrogen and methyl or ethyl radicals.

Examples of optionally substituted hydrocarbon radicals R² are the examples given for radical R having 8 to 20 carbon atoms, and also alkyl radicals such as the lauryl, isotridecyl, palmityl and stearyl radicals; cycloalkyl radicals such as the cyclohexylbutyl radical; and also alkenyl radicals such as the undecenyl, hexadecenyl and oleyl radical.

Preferably the radicals R² are optionally halogen-substituted hydrocarbon radicals having 8 to 20 carbon atoms, more preferably hydrocarbon radicals having 8 to 20 carbon atoms, in particular octyl radicals such as the n-octyl radical, isooctyl radicals and the 2,2,4-trimethylpentyl radical; nonyl radicals such as the n-nonyl radical; decyl radicals such as the n-decyl radical; dodecyl radicals such as the n-dodecyl radical; tridecyl radicals such as the isotridecyl radical; hexadecyl radicals such as the n-hexadecyl radical; octadecyl radicals such as the n-octadecyl radical; cycloalkyl radicals such as the 4-cyclohexylbutyl radical, and alkenyl radicals such as the undecenyl, hexadecenyl, and oleyl radical.

Preferably, radical A is a radical having precisely one OH group and precisely one ester moiety, particularly a radical where the carbon bearing the OH group bonds via a CH or CH₂ radical to the —O— of the ester group.

Preferred radicals for A are
—CH₂CH₂CH₂OCH₂CH(OH)CH₂OC(═O)CH₂—,
—CH₂CH₂CH₂OCH₂CH(CH₂OH)OC(═O)CH₂—,
—CH₂CH₂CH₂CH₂CH(OH)CH₂OC(═O)CH₂—,
—CH₂CH₂CH₂CH₂CH(CH₂OH)OC(═O)CH₂—,

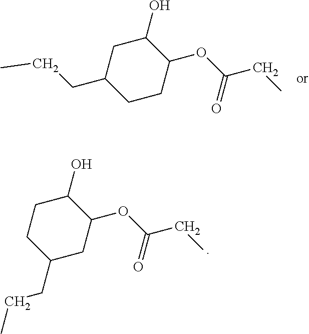

It is more preferable that moiety A is
—CH₂CH₂CH₂OCH₂CH(OH)CH₂OC(═O)CH₂— and
—CH₂CH₂CH₂OCH₂CH(CH₂OH)OC(═O)CH₂—.

Examples of compounds of the invention of the formula (I) are
(MeO)₃Si—CH₂CH₂CH₂OCH₂CH(OH)CH₂OC(═O)CH₂—O(CH₂CH₂O)₂₋₆—C₈H₁₇,
(EtO)₂MeSi—CH₂CH₂CH₂OCH₂CH(OH)CH₂OC(═O)CH₂—O(CH₂CH₂O)₂₋₆—C₈H₁₇,
(MeO)₃Si—CH₂CH₂CH₂OCH₂CH(OH)CH₂OC(═O)CH₂—O(CH₂CH₂O)₅₋₈—(CH₂)₁₁₋₁₃CH₃,
(EtO)₃Si—CH₂CH₂CH₂OCH₂CH(OH)CH₂OC(═O)CH₂—O(CH₂CH₂O)₂₋₆—(CH₂)₁₁₋₁₃CH₃,
(MeO)₂MeSi—CH₂CH₂CH₂OCH₂CH(OH)CH₂OC(═O)CH₂—O(CH₂CH₂O)₈₋₁₂-iso-C₁₃H₂₇,
(EtO)₃Si—CH₂CH₂CH₂OCH₂CH(OH)CH₂OC(═O)CH₂—O(CH₂CH₂O)₂₋₆-iso-C₁₃H₂₇,
(MeO)₂HOSi—CH₂CH₂CH₂OCH₂CH(OH)CH₂OC(═O)CH₂—O(CH₂CH₂O)₂₋₆—(CH₂)₈CH═CH(CH₂)₅₋₇CH₃,
(HO)₃Si—CH₂CH₂CH₂OCH₂CH(OH)CH₂OC(═O)CH₂—O(CH₂CH₂O)₂₋₆—(CH₂)₈CH═CH(CH₂)₅₋₇CH₃,
(MeO)₂MeSi—CH₂CH₂CH₂OCH₂CH(CH₂OH)OC(═O)CH₂—O(CH₂CH₂O)₂₋₆—C₈H₁₇,
(EtO)₃Si—CH₂CH₂CH₂OCH₂CH(CH₂OH)OC(═O)CH₂—O(CH₂CH₂O)₂₋₆—C₈H₁₇,
(MeO)₃Si—CH₂CH₂CH₂OCH₂CH(CH₂OH)OC(═O)CH₂—O(CH₂CH₂O)₅₋₈—(CH₂)₁₁₋₁₃CH₃,
(EtO)₂HOSi—CH₂CH₂CH₂OCH₂CH(CH₂OH)OC(═O)CH₂—O(CH₂CH₂O)₂₋₆—(CH₂)₁₁₋₁₃CH₃,
(MeO)₃Si—CH₂CH₂CH₂OCH₂CH(CH₂OH)OC(═O)CH₂—O(CH₂CH₂O)₈₋₁₂-iso-C₁₃H₂₇,
(EtO)₃Si—CH₂CH₂CH₂OCH₂CH(CH₂(OH))OC(═O)CH₂—O(CH₂CH₂O)₂₋₆-iso-C₁₃H₂₇,
(MeO)(HO)₂Si—CH₂CH₂CH₂OCH₂CH(CH₂OH)OC(═O)CH₂—O(CH₂CH₂O)₂₋₆—(CH₂)₈CH═CH(CH₂)₅₋₇CH₃,
(EtO)₃Si—CH₂CH₂CH₂OCH₂CH(CH₂OH)OC(═O)CH₂—O(CH₂CH₂O)₂₋₆—(CH₂)₈CH═CH(CH₂)₅₋₇CH₃,
(MeO)₃Si—CH₂CH₂CH₂CH₂CH(OH)CH₂OC(═O)CH₂—O(CH₂CH₂O)₂₋₆—C₈H₁₇,
(EtO)₂MeSi—CH₂CH₂CH₂CH₂CH(OH)CH₂OC(═O)CH₂—O(CH₂CH₂O)₂₋₆—C₈H₁₇,
(MeO)₂MeSi—CH₂CH₂CH₂CH₂CH(CH₂OH)OC(═O)CH₂—O(CH₂CH₂O)₂₋₆—C₈H₁₇,
(EtO)₃Si—CH₂CH₂CH₂CH₂CH(CH₂OH)OC(═O)CH₂—O(CH₂CH₂O)₂₋₆—C₈H₁₇, and

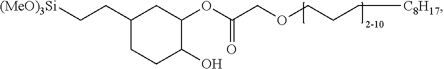

where Me is methyl radical and Et is ethyl radical.

Preferably, the compounds of the formula (I) are
(MeO)₃Si—CH₂CH₂CH₂OCH₂CH(OH)CH₂OC(═O)CH₂—O(CH₂CH₂O)₂₋₁₅—C₈H₁₇,
(EtO)₃Si—CH₂CH₂CH₂OCH₂CH(OH)CH₂OC(═O)CH₂—O(CH₂CH₂O)₂₋₁₅—C₈H₁₇,
(MeO)₃Si—CH₂CH₂CH₂OCH₂CH(OH)CH₂OC(═O)CH₂—O(CH₂CH₂O)₂₋₁₅—(CH₂)₁₁₋₁₃CH₃,
(EtO)₃Si—CH₂CH₂CH₂OCH₂CH(OH)CH₂OC(═O)CH₂—O(CH₂CH₂O)₂₋₁₅—(CH₂)₁₁₋₁₃CH₃,
(MeO)₃Si—CH₂CH₂CH₂OCH₂CH(OH)CH₂OC(═O)CH₂—O(CH₂CH₂O)₂₋₁₅-iso-C₁₃H₂₇,
(EtO)₃Si—CH₂CH₂CH₂OCH₂CH(OH)CH₂OC(═O)CH₂—O(CH₂CH₂O)₂₋₁₅-iso-C₁₃H₂₇,
(MeO)₃Si—CH₂CH₂CH₂OCH₂CH(OH)CH₂OC(═O)CH₂—O(CH₂CH₂O)₂₋₁₅—(CH₂)₈CH═CH(CH₂)₅₋₇CH₃,
(EtO)₃Si—CH₂CH₂CH₂OCH₂CH(OH)CH₂OC(═O)CH₂—O(CH₂CH₂O)₂₋₁₅—(CH₂)₈CH═CH(CH₂)₅₋₇CH₃,
(MeO)₃Si—CH₂CH₂CH₂OCH₂CH(CH₂OH)OC(═O)CH₂—O(CH₂CH₂O)₂₋₁₅—C₈H₁₇,
(EtO)₃Si—CH₂CH₂CH₂OCH₂CH(CH₂OH)OC(═O)CH₂—O(CH₂CH₂O)₂₋₁₅—C₈H₁₇,
(MeO)₃Si—CH₂CH₂CH₂OCH₂CH(CH₂OH)OC(═O)CH₂—O(CH₂CH₂O)₂₋₁₅—(CH₂)₁₁₋₁₃CH₃,
(EtO)₃Si—CH₂CH₂CH₂OCH₂CH(CH₂OH)OC(═O)CH₂—O(CH₂CH₂O)₂₋₁₅—(CH₂)₁₁₋₁₃CH₃,
(MeO)₃Si—CH₂CH₂CH₂OCH₂CH(CH₂OH)OC(═O)CH₂—O(CH₂CH₂O)₂₋₁₅-iso-C₁₃H₂₇,
(EtO)₃Si—CH₂CH₂CH₂OCH₂CH(CH₂(OH))OC(═O)CH₂—O(CH₂CH₂O)₂₋₁₅-iso-C₁₃H₂₇,
(MeO)₃Si—CH₂CH₂CH₂OCH₂CH(CH₂OH)OC(═O)CH₂—O(CH₂CH₂O)₂₋₁₅—(CH₂)₈CH═CH(CH₂)₅₋₇CH₃,
(EtO)₃Si—CH₂CH₂CH₂OCH₂CH(CH₂OH)OC(═O)CH₂—O(CH₂CH₂O)₂₋₁₅—(CH₂)₈CH═CH(CH₂)₅₋₇CH₃, more preferably
(MeO)₃Si—CH₂CH₂CH₂OCH₂CH(OH)CH₂OC(═O)CH₂—O(CH₂CH₂O)₃₋₁₀—C₈H₁₇,
(EtO)₃Si—CH₂CH₂CH₂OCH₂CH(OH)CH₂OC(═O)CH₂—O(CH₂CH₂O)₃₋₁₀—C₈H₁₇,
(MeO)₃Si—CH₂CH₂CH₂OCH₂CH(OH)CH₂OC(═O)CH₂—O(CH₂CH₂O)₃₋₁₀—(CH₂)₁₁₋₁₃CH₃,
(EtO)₃Si—CH₂CH₂CH₂OCH₂CH(OH)CH₂OC(═O)CH₂—O(CH₂CH₂O)₃₋₁₀—(CH₂)₁₁₋₁₃CH₃,
(MeO)₂MeSi—CH₂CH₂CH₂OCH₂CH(OH)CH₂OC(═O)CH₂—O(CH₂CH₂O)₃₋₁₀-iso-C₁₃H₂₇,
(EtO)₃Si—CH₂CH₂CH₂OCH₂CH(OH)CH₂OC(═O)CH₂—O(CH₂CH₂O)₃₋₁₀-iso-C₁₃H₂₇,
(MeO)₃Si—CH₂CH₂CH₂OCH₂CH(CH₂OH)OC(═O)CH₂—O(CH₂CH₂O)₃₋₁₀—C₈H₁₇,
(EtO)₃Si—CH₂CH₂CH₂OCH₂CH(CH₂OH)OC(═O)CH₂—O(CH₂CH₂O)₃₋₁₀—C₈H₁₇,
(MeO)₃Si—CH₂CH₂CH₂OCH₂CH(CH₂OH)OC(═O)CH₂—O(CH₂CH₂O)₃₋₁₀—(CH₂)₁₁₋₁₃CH₃,
(EtO)₃Si—CH₂CH₂CH₂OCH₂CH(CH₂OH)OC(═O)CH₂—O(CH₂CH₂O)₃₋₁₀—(CH₂)₁₁₋₁₃CH₃,
(MeO)₃Si—CH₂CH₂CH₂OCH₂CH(CH₂OH)OC(═O)CH₂—O(CH₂CH₂O)₃₋₁₀-iso-C₁₃H₂₇,
(EtO)₃Si—CH₂CH₂CH₂OCH₂CH(CH₂(OH))OC(═O)CH₂—O(CH₂CH₂O)₃₋₁₀-iso-C₁₃H₂₇.

At room temperature and 1013 hPa, the compounds of the formula (I) are preferably clear to slightly cloudy, colorless to yellowish liquids.

The compounds of the formula (I) can be produced by conventional methods in chemistry. For example, the siloxy-substituted polyether can be produced via an addition reaction of epoxy-functional silanes onto commercially available hydrated alkyl (polyethylene glycol) ether carboxylates, catalyzed by 1,4-diazabicyclo[2.2.2]octane.

The invention further provides a process for the production of the compounds of the formula (I) via an addition reaction in the presence of catalyst which promotes the addition reaction of epoxy groups onto carboxy groups of epoxy-functional silanes onto polyethylene glycols, which, at one end, bear a carboxymethyl group (—CH₂—COOH) and, at the other end, have a hydrocarbon radical having 8 to 20 carbon atoms.

The epoxy groups of the silanes are preferably glycidoxy groups or epoxidized double bonds.

Preferably, the polyethylene glycols, which, at one end, bear a carboxymethyl group (—CH₂—COOH) and, at the other end, have a hydrocarbon radical having 8 to 20 carbon atoms, have a residual moisture level below 0.2% by weight. It can be advantageous to use commercially available polyethylene glycols, which have, at one end, a carboxymethyl group and, at the other end, a hydrocarbon radical having 8 to 20 carbon atoms, and to hydrate these before they are used, preferably at temperatures between 50 and 150° C. and at an absolute pressure from 1 hPa to 100 hPa.

The process uses epoxy-functional silanes and polyethylene glycols which, at one end, bear a carboxymethyl group (—CH₂—COOH) and, at the other end, have a hydrocarbon radical having 8 to 20 carbon atoms in a molar ratio from 1:1.2 to 1.2:1, more preferably 1:1.

The conditions under which the process can be carried out are the same as those for the epoxy-carboxy reactions. The process is preferably carried out at temperatures between 20 and 150° C., at the atmospheric pressure, i.e. generally about 1013 hPa. It is preferable to carry out the epoxy-carboxy reaction, particularly the reaction of α-carboxymethyl-ω-alkylpoly(ethylene glycol) with epoxy-functional tri- or dialkoxymethylsilanes, without addition of a solvent.

Compounds that assist the epoxy-carboxy reaction can be used as a catalyst in the process. Examples of catalysts that promote the addition reaction of epoxy groups onto carboxy groups are the examples mentioned in EP 1235646 B1, page 2, line 21, to page 3, line 34, which are incorporated herein by reference. Preferably, that the catalyst used in the invention is 1,4-diazabicyclo[2.2.2]octane.

Once the epoxy-carboxy reaction has taken place, the reaction mixture can be processed by any suitable method. Preferably, the catalyst is removed by using acidic ion exchanger or via treatment with silica gel or activated charcoal. The solid residues can then be separated from the reaction product via filtration or decanting.

The components used in the process of the invention can be one type of any component or a mixture of at least two types of any component, and are commercially available products or can be produced by processes commonly used in chemistry.

The compounds of the formula (I) of the invention or compounds of the formula (I) can then be used for any desired purpose, e.g. as addition in paints, varnishes, renders, adhesives, and sealants, or as an addition to coating compositions for construction materials such as concrete, silicates, gypsum plaster, glass, or wood.

The invention further provides crosslinkable compositions comprising compounds of the formula (I).

The compositions can be any desired types of compositions which can be crosslinked to give elastomers and which are based on organosilicon compounds, for example, single-component or two-component vulcanizable organopolysiloxane compositions. The crosslinkable compositions can be free from fillers, but can also comprise active or inert fillers.

The compositions are preferably compositions which can be crosslinked via a condensation reaction, preferably single-component compositions that can be stored with the exclusion of water and that are crosslinkable at room temperature in the presence of water (RTV-1). However, the compositions can also be two-component compositions which can be crosslinked via a condensation reaction.

The nature and quantity of the components usually used in compositions of this type are already known. Preferably, the crosslinkable are compositions which comprise, alongside the compounds of the formula (I), organopolysiloxanes having at least two condensable radicals, optionally a crosslinking agent having at least three hydrolyzable radicals, optionally a condensation catalyst, optionally fillers, and optionally additives.

The quantities of compounds of the formula (I) present in the compositions are preferably from 0.1 to 5% by weight, more preferably from 0.2 to 2% by weight.

The crosslinking of the compositions can be carried out under the conditions known for that purpose: for example, the usual water content of the air is sufficient in the case of the more preferred RTV-1 compositions, where the crosslinking is preferably carried out at room temperature and at the atmospheric pressure, i.e. about 900 to 1,100 hPa.

The present invention further provides moldings produced via crosslinking of the compositions of the invention.

The present invention further provides a process for modification of substance surfaces, by applying the compounds of the formula (I) to a surface of a substrate.

The substrates used in the invention are preferably hardened silicone elastomers, glass surfaces, surfaces of silicatic construction materials such as concrete, stoneware, and porcelain, or metals such as steel and aluminum, and also plastics such as PVC, PMMA, or polycarbonate.

When the compounds of the formula (I) are applied to the substrate surface, it can be advantageous to use an organic solvent, e.g. mixtures of aliphatic hydrocarbons, for example, obtainable under tradename “Shellsol D60”, or ethers, e.g. tetrahydrofuran. Another preferred variant is the use of compounds of the formula (I) in an aqueous solution or as emulsion. The respective substance can be applied by known methods, for example, via brushing, wiping, spraying, application by a roller, or immersion.

In addition to compounds of the formula (I), process for the modification of substrate surfaces can, if desired, use other components, e.g. condensation catalysts.

The condensation catalysts optionally used in the process can be any curing accelerator useful in compositions which can be crosslinked via a condensation reaction, for example, titanium compounds and organic tin compounds.

Preferably, condensation catalysts are used in the process for the modification of surfaces. Once the surfaces have been treated, these can be freed in a manner known from the solvents optionally used, for example, by what is known as natural drying, i.e. evaporation at room temperature and atmospheric pressure.

The modified surfaces modified have the advantage of being durably hydrophilic.

An advantage of the compounds of the invention is that they are easy to produce and that even a small quantity has a very powerful hydrophilizing effect, even when the compounds are added to crosslinkable compositions. Furthermore, the effect is also retained over a relatively long period, i.e. it is not subject to any reduction due to rehydrophobization of the hydrophilizing layer by migrating siloxanes.

An advantage of the compounds is that even small quantities of the compounds provide permanent hydrophilic properties to siloxane elastomer surfaces.

In the examples described below, all viscosity data are based on a temperature of 25° C. Unless otherwise stated, the examples below are carried out at the atmospheric pressure, i.e. at about 1,000 hPa, and at room temperature, i.e. at about 23° C., or at a temperature that results when the reactants are combined at room temperature without additional heating or cooling, and at a relative humidity of about 50%. All data relating to parts and percentages are moreover based on weight unless otherwise stated.

In order to assess the run-off angle of water droplets on the surface after 49 shower cycles (Test 1), each of the crosslinkable compositions is applied in a layer of thickness 2 mm to PE foil and hardened for seven days at 23° C. and 50% relative humidity. The skin is then placed at an angle of 30° to the horizontal in a shower tester and showered seven times per day for five minutes. The skin is then placed in a quadrant in such a way that the skin covers the area from horizontal (=0°) to vertical (=90°). Four water droplets of 6 μl, 10 μl, 15 μl and 20 μl are applied at an angle greater than 50°, and the run-off angle is read at the lower edge of the droplet after 5 min. The values are determined and recorded with accuracy +/−1 degree.

### EXAMPLE 1

### Production of (Product 1)

(CH₃O)₃Si—CH₂CH₂CH₂OCH₂CH(OH)CH₂OC(═O)CH₂—O(CH₂CH₂O)_{2 -6}—(CH₂)₁₁₋₁₃CH₃ and
(CH₃O)₃Si—CH₂CH₂CH₂OCH₂CH(CH₂OH)OC(═O)CH₂—O(CH₂CH₂O)₂₋₆—(CH₂)₁₁₋₁₃CH₃

In a glass flask with Liebig condenser and receiver, 100 g of glycolic acid ethoxylate lauryl ether (Mn=460 g/mol) (obtainable commercially as AKYPO RLM 45 CA from KAO Chemicals GmbH, Emmerich, Germany) were stirred at 100° C. and 20 mbar until no further separation of water occurred. After nitrogen aeration, 47 g of (3-glycidoxypropyl)trimethoxysilane (obtainable commercially with trademark GENIOSIL® GF 80 from Wacker Chemie AG, Munich, Germany) and 0.5 g of 1,4-diazabicyclo[2.2.2]octane (obtainable commercially as DABCO® from Sigma-Aldrich Chemie GmbH, Taufkirchen, Germany) were added and stirred at 100° C. for two hours. Cooling and filtration gives 135 g of a yellowish liquid. ¹³C NMR and titration revealed over 80% adduct formation.

1 g of Product 1 was mixed twice, on each occasion for one minute at 3,000 rpm, in a Hauschild mixer with 100 g of a RTV1 paste, which is stable in storage in the absence of atmospheric moisture and crosslinked with elimination of alcohols in the presence of atmospheric moisture (obtainable commercially with trademark ELASTOSIL® EL7000N IRAN S1 from Wacker Chemie AG, Munich, Germany). Test 1 was carried out with the resultant composition. The results are found in table 1.

### EXAMPLE 2

### Production of (Product 2)

(EtO)₃Si—CH₂CH₂CH₂OCH₂CH(OH)CH₂OC(═O)CH₂—O(CH₂CH₂O)₅₋₉-iso-C₁₃H₂₇ and
(EtO)₃Si—CH₂CH₂CH₂OCH₂CH(CH₂OH)OC(═O)CH₂—O(CH₂CH₂O)₅₋₉-iso-C₁₃H₂₇

In a glass flask with Liebig condenser and receiver, 100 g of glycolic acid ethoxylate isotridecanol ether (Mn=570 g/mol) (obtainable commercially as Marlowet 4538 from Sasol Germany GmbH, Hamburg, Germany) were stirred at 100° C. and 20 mbar until no further separation of water occurred. After nitrogen aeration, 45 g of (3-glycidoxypropyl)trimethoxysilane (obtainable commercially with trademark GENIOSIL® GF 82 from Wacker Chemie AG, Munich, Germany) and 0.5 g of 1,4-diazabicyclo[2.2.2]octane (obtainable commercially as DABCO® from Sigma-Aldrich Chemie GmbH, Taufkirchen, Germany) were added and stirred at 100° C. for two hours. Cooling and filtration gives 137 g of a yellowish liquid. ¹³C NMR and titration revealed over 80% adduct formation.

The procedure described in example 1 is repeated, except that 1 g of Product 2 is used instead of Product 1. The results are found in table 1.

### EXAMPLE 3

### Production of (Product 3)

(CH₃O)₃Si—CH₂CH₂CH₂OCH₂CH(OH)CH₂OC(═O)CH₂—O(CH₂CH₂O)₃₋₇—(CH₂)₈CH═CH(CH₂)₅₋₇CH₃ and
(CH₃O)₃Si—CH₂CH₂CH₂OCH₂CH(CH₂(OH))OC(═O)CH₂—O(CH₂CH₂O)₃₋₇—(CH₂)₈CH═CH(CH₂)₅₋₇CH₃

In a glass flask with Liebig condenser and receiver, 105 g of glycolic acid ethoxylate oleyl ether (Mn=540 g/mol) (obtainable commercially as AKYPO RO 50 VG from KAO Chemicals GmbH, Emmerich, Germany) were stirred at 100° C. and 20 mbar until no further separation of water occurred. After nitrogen aeration, 43 g of (3-glycidoxypropyl)trimethoxysilane (obtainable commercially with trademark GENIOSIL® GF 80 from Wacker Chemie AG, Munich, Germany) and 0.5 g of 1,4-diazabicyclo[2.2.2]octane (obtainable commercially as DABCO® from Sigma-Aldrich Chemie GmbH, Taufkirchen, Germany) were added and stirred at 100° C. for two hours. Cooling and filtration gives 138 g of a cloudy and yellowish liquid. ¹³C NMR and titration revealed approximately 75% adduct formation.

The procedure described in example 1 is repeated, except that 1 g of Product 3 is used instead of Product 1. The results are found in table 1.

### EXAMPLE 4

### Production of (Product 4)

(CH₃O)₃Si—CH₂CH₂CH₂OCH₂CH(OH)CH₂OC(═O)CH₂—O(CH₂CH₂O)₆₋₁₀—(CH₂)₇CH₃ and
(CH₃O)₃Si—CH₂CH₂CH₂OCH₂CH(CH₂(OH))OC(═O)CH₂—O(CH₂CH₂O)₆₋₁₀—(CH₂)₇CH₃

In a glass flask with Liebig condenser and receiver, 105 g of glycolic acid ethoxylate capryl ether (Mn=547 g/mol) (obtainable commercially as AKYPO LF 2 from KAO Chemicals GmbH, Emmerich, Germany) were stirred at 100° C. and 20 mbar until no further separation of water occurred. After nitrogen aeration, 45 g of (3-glycidoxypropyl)trimethoxysilane (obtainable commercially with trademark GENIOSIL® GF 80 from Wacker Chemie AG, Munich, Germany) and 0.5 g of 1,4-diazabicyclo[2.2.2]octane (obtainable commercially as DABCO® from Sigma-Aldrich Chemie GmbH, Taufkirchen, Germany) were added and stirred at 100° C. for two hours. Cooling and filtration gives 140 g of a light yellow liquid. ¹³C NMR and titration revealed approximately 85% adduct formation.

The procedure described in example 1 is repeated, except that 1 g of Product 4 is used instead of Product 1. The results are found in table 1.

### COMPARATIVE EXAMPLE 1 (C1)

The procedure described in example 1 is repeated, except that no Product 1 is used. The results are found in table 1.

TABLE 1

| | Run-off | Run-off | Run-off | Run-off |
|---|---|---|---|---|
| | angle 20 μl, | angle 15 μl, | angle 10 μl, | angle 6 μl, |
| Example | in degrees | in degrees | in degrees | in degrees |
| 1 | 8 | 10 | 11 | 17 |
| 2 | 5 | 13 | 20 | 42 |
| 3 | 10 | 12 | 15 | 20 |
| 4 | 10 | 13 | 17 | 35 |
| C1 | 35 | >50 | >50 | >50 |

1.-9. (canceled)

10. A composition comprising a compound of the formula
(R¹O)ₐR₃₋ₐSi-A-O(CH₂CH₂—O)ₓ—R² (I),
where
R each are identical or different monovalent, optionally substituted hydrocarbon radicals,
R¹ each are identical or different and are hydrogen or monovalent, optionally substituted hydrocarbon radicals,
A is a divalent, optionally substituted hydrocarbon radical comprising a hydroxyl group and an ester group (—O—C(═O)—), which is optionally interrupted by oxygen atoms, and is bonded via carbon to Si and to O,
R² each is a monovalent, optionally substituted hydrocarbon radical having 8 to 20 carbon atoms,
a is 1, 2, or 3, and
x is an integer from 1 to 20.

11. The compound of claim 10, wherein at least one radical A is a radical comprising only one OH group and only one ester radical, wherein the carbon atom bearing the OH group is bonded via a CH or CH₂ radical to the —O— of the ester group.

12. The compound of claim 10, wherein at least one radical R² is an octyl, nonyl, decyl, dodecyl, tridecyl, hexadecyl, octadecyl, cycloalkyl, undecenyl, hexadecenyl, or oleyl radical.

13. The compound of claim 11, wherein at least one radical R² is an octyl, nonyl, decyl, dodecyl, tridecyl, hexadecyl, octadecyl, cycloalkyl, undecenyl, hexadecenyl, or oleyl radical.

14. A process for production of at least one compound of formula (I) of claim 10, comprising reacting epoxy-functional silanes onto polyethylene glycols comprising at least one carboxymethyl group (—CH₂—COOH) and at least one terminal hydrocarbon radical having 8 to 20 carbon atoms via an addition reaction, in the presence of at least one catalyst promoting the addition reaction.

15. The process of claim 14, wherein at least one epoxy group of the silane is a glycidoxy group or an epoxidized double bond.

16. A crosslinkable composition comprising at least two compound of the formula (I) of claim 10.

17. A crosslinkable composition comprising at least two compounds of the formula (I) of claim 11.

18. A crosslinkable composition comprising at least two compounds of the formula (I) of claim 12.

19. A crosslinkable composition comprising at least two compounds of the formula (I) produced by the process of claim 14.

20. A crosslinkable composition comprising at least two compounds of the formula (I) produced by the process of claim 15.

21. The crosslinkable composition of claim 16, wherein the composition is a single-component composition storable with exclusion of water and crosslinkable at room temperature in a presence of water (RTV-1).

22. A molding produced via crosslinking of the composition of claim 16.

23. A molding produced via crosslinking of the composition of claim 21.

24. A process for modification of at least one surface of at least one substrate comprising applying to the at least one surface of the at least one substrate, at least one composition comprising a compound of the formula (I) of claim 10.

25. A process for modification of at least one surface of at least one substrate comprising applying to the at least one surface of the at least one substrate, at least one composition comprising a compound of the formula (I) of claim 11.

26. A process for modification of at least one surface of at least one substrate by applying to the at least one surface of the at least one substrate, at least one composition comprising a compound of the formula (I) of claim 12.

27. A process for modification of at least one surface of at least one substrate by applying to the at least one surface of the at least one substrate, at least one composition comprising a compound of the formula (I) produced by the process of claim 14.

28. A process for modification of at least one surface of at least one composition comprising a substrate by applying to the at least one surface of the at least one substrate, at least one compound of the formula (I) produced by the process of claim 15.
